(19) United States
(12) Patent Application Publication
(10) Pub. No.: US 2025/0360748 A1
(43) Pub. Date: Nov. 27, 2025

(54) DIAMOND PAINTING KITS, METHODS, AND PROCESSES

(71) Applicant: UNWIND DESIGNS LLC, DES MOINES, IA (US)

(72) Inventors: Aileen Hunnell, DES MOINES, IA (US); Mikayla Osman, Des Moines, IA (US)

(21) Appl. No.: 19/217,546

(22) Filed: May 23, 2025

Related U.S. Application Data
(60) Provisional application No. 63/651,014, filed on May 23, 2024.

(51) Int. Cl. B44C 1/18

(52) U.S. Cl. CPC B44C 1/18

(57) ABSTRACT

Painting or coloring kits for diamond beads or jewels designed to foster creativity and imagination in a teaching setting, including diamond beads being placed on coloring sheets or objects. The painting or coloring kits can include a plurality of diamond beads, a utensil for grabbing individual diamond beads, and a drawing sheet for applying or attaching the plurality of diamond beads to, wherein the drawing sheet does not include a legend or a mapped image of bubbles with letters, number, or symbols therein to foster creativity and imagination when jeweling.

### CROSS REFERENCE TO RELATED APPLICATIONS

This application claims priority under 35 U.S.C. § 119(e) to provisional patent application U.S. Ser. No. 63/651,014, filed May 23, 2024. The provisional patent application is hereby incorporated by reference in its entirety herein, including without limitation: the specification, claims, and abstract, as well as any figures, tables, appendices, or drawings thereof.

### TECHNICAL FIELD

The disclosure includes kits, methods, and processes for painting diamond beads on cardstock, objects, or other surfaces. The application of diamond beads to a surface with relation to a kit applies to amateur artists as well as classroom and teaching environments for fostering creativity and imagination.

### BACKGROUND

Painting with diamond beads has traditionally been a hobby in which artists or novices can take time to follow a mapped or systematic painting scheme on a canvas to turn the canvas from a bland and mapped picture of hundreds-to-thousands of bubbles, with numbers, letters, or symbols inside those bubbles, to a beautiful painting filled with color. This beautiful painting often has a unique look to it opposed to other forms of art in that the mini diamond-shaped pieces, often made of some form of plastic, that have been specifically placed on the number-coordinated bubbles, reflect light at different angles due to the diamond-shape, and has a similar quality to looking like a mosaic once the diamond art canvas has been completed. Due to the small size of these diamond beads (˜2-3 millimeters in diameter), it takes great patience to finish a single canvas placing thousands of these diamond beads, and without a mapped system of the bubbles on the canvas that tell the artist where to place the specific colors, it can be difficult to create a work of art with these diamonds that ends up resembling what the artist wants it to look like in the end (imagine on a computer trying to paint the entire screen of a window opened in the Windows Paint app by only being allowed to click and fill-in one screen pixel at a time). However, these mapped diamond canvases do not foster creativity as it is simply an exercise of the sequential iteration of look at a bubble on the canvas, identify the number, letter, or symbol within the bubble, find the color of diamond associated with that identifier, place the diamond, and repeat.

Further, these diamond art canvases have traditionally been completed by using glue to connect the diamonds to the canvas, or using double sided sticky tape for the canvas which often forces the artist to try and get it all done in one sitting, and the diamonds have often been contained in envelopes which result in a messy workspace.

Therefore, there is a need in the art for improved methods, systems, and kits to improve diamond painting, and to foster creativity and imagination in teaching settings while using diamond painting.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the present invention.

Methods can be practiced which facilitate use, manufacture, assembly, maintenance, and repair of the kit which accomplish some or all of the previously stated objectives.

According to some aspects of the present disclosure, a diamond painting kit for jeweling, the kit comprising: a housing; a plurality of containers within the housing, the plurality of containers each containing a unique color of a plurality of diamond beads; a drawing sheet; a utensil; and an optically clear double-sided mounting film.

According to some additional aspects of the present disclosure, the mentioned kit, wherein the optically clear double-sided mounting film comprises an optically clear mounting adhesive.

According to some other aspects of the present disclosure the mentioned kit of any of the previously mentioned kits, wherein the utensil is configured to grip a single diamond bead from the plurality of diamond beads, the utensil comprising: a shaft; a grip surrounding the shaft; and a tip at a first end of the shaft, the tip being conical in shape with an aperture at a periphery of the tip, and the tip tapering to a vertex connected with the first end of the shaft.

According to some other aspects of the present disclosure the mentioned kit of any of the previously mentioned kits not including the utensil with a grip, wherein the utensil comprises a colorless pencil.

According to some other aspects of the present disclosure the mentioned kit of any of the previously mentioned kits further comprising a wax shape, and a bead tray, wherein the bead tray funnels toward a first end of the bead tray to a width that can accommodate no more than of the combined width of two diamond beads side-by-side.

According to some other aspects of the present disclosure the mentioned kit of any of the previously mentioned kits, further comprising a paperclip.

According to some other aspects of the present disclosure the mentioned kit of any of the previously mentioned kits, wherein the drawing sheet is a blank drawing sheet.

According to some other aspects of the present disclosure the mentioned kit of any of the previously mentioned kits, wherein the drawing sheet has a premade image thereon.

According to some other aspects of the present disclosure the mentioned kit of any of the previously mentioned kits, wherein the drawing sheet further has pre-applied colors to the premade image.

According to some other aspects of the present disclosure the mentioned kit of any of the previously mentioned kits, wherein the drawing sheet does not include a mapped image with identifier-marked bubbles and further does not include a legend.

According to some other aspects of the present disclosure the mentioned kit of any of the previously mentioned kits, further including a water sprayer.

According to some other aspects of the present disclosure the mentioned kit of any of the previously mentioned kits, wherein the plurality of containers comprises twenty containers each in a parallelepiped shape.

According to some aspects of the present disclosure, a diamond kit for jeweling, the kit including: a package; a housing within the package; a plurality of containers within the housing, the plurality of containers each containing a unique color of a plurality of diamond beads; an object within the package; a wax crayon within the package; and an optically clear double-sided mounting film within the package.

According to some additional aspects of the present disclosure, the mentioned kit that includes a package, wherein the optically clear double-sided mounting film comprises an optically clear mounting adhesive.

According to some other aspects of the present disclosure the mentioned kit with a package of any of the previously mentioned kits with a package, further comprising a wax shape, and a bead tray, wherein the bead tray funnels toward a first end of the bead tray to a width that can accommodate no more than the combined width of two diamond beads side-by-side.

According to some other aspects of the present disclosure the mentioned kit with a package of any of the previously mentioned kits with a package, further including a water sprayer.

According to some other aspects of the present disclosure the mentioned kit with a package of any of the previously mentioned kits with a package, wherein the plurality of containers comprises 4 containers each in a parallelepiped shape, the plurality of containers in an at least one row.

According to some other aspects of the present disclosure the mentioned kit with a package of any of the previously mentioned kits with a package, wherein the object is glasses.

According to some aspects of the present disclosure, a process for teaching students how to jewel, the process comprising: opening a diamond painting kit including a plurality of containers each holding differing colors of a plurality of diamond beads, the diamond painting kit further including a utensil, a bead tray, a mounting film, and a blank drawing sheet; peeling a first peelable side from the mounting film; applying the mounting film to the blank drawing sheet; peeling a second peelable side from the mounting film; opening at least one of the plurality of containers; and applying at least one of the plurality of diamond beads to the mounting film.

According to some other aspects of the present disclosure, the previously mentioned process, further comprising drawing on the blank drawing sheet before applying the mounting film to the blank drawing sheet.

According to some other aspects of the present disclosure, the first previously mentioned process, wherein the blank drawing sheet has a pre-made image disposed thereon without a mapped image and without a legend.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Several embodiments in which the present invention can be practiced are illustrated and described in detail, wherein like reference characters represent like components throughout the several views. The drawings are presented for exemplary purposes and may not be to scale unless otherwise indicated.

FIG. 1A shows a plan view of a diamond painting kit.

FIG. 1B shows a plan view of an opened diamond painting kit of FIG. 1A.

FIG. 2 shows a perspective view of individual components that came from the diamond painting kit of FIGS. 1A and 1B.

FIG. 3 shows a perspective view of optional components to be included in the diamond painting kit of FIG. 1A and 1B.

FIG. 4A shows a perspective view of a drawing sheet covered with a double-sided mounting film, and a water sprayer.

FIG. 4B shows a plan view of a blank drawing sheet and a water sprayer.

FIG. 4C shows a perspective view of an optically clear double-sided mounting film.

FIG. 4D shows a user peeling back a layer of the optically clear doubled-sided mounting film.

FIG. 5 shows a method of using the diamond painting kit.

FIG. 6 shows a plan view of a before and after of a drawing sheet without and with diamond beads.

FIG. 7 shows a perspective view of a pair of sunglasses that has had diamond beads applied to them, and a keychain object that can be painted with diamond beads.

FIG. 8 shows a plan view of packaging for the pair of sunglasses of FIG. 7.

FIG. 9 shows a method for painting diamond beads onto sunglasses.

FIG. 10 shows a perspective view of alternative objects that can be included in kits to be painted on.

FIG. 11 shows a perspective view of an alternative object that can be painted on.

FIG. 12 shows a plan view of an alternative embodiment for a utensil or coloring pen—a colorless pencil.

FIG. 13A shows the beginning of a method to apply an optically clear double-sided mounting film to a blank drawing sheet.

FIG. 13B shows the next step in the method of applying the optically clear double-sided mounting film to the blank drawing sheet by separating an outer layer of the mounting film to reveal an adhesive that is sticking to the blank drawing sheet.

FIG. 13C shows the mounting film applied to the blank drawing sheet, including a lift-here tab.

FIG. 13D shows a user removing a second outer layer of the mounting film to reveal a second adhesive atop a polyester film (of the mounting film), said polyester film attached to the blank drawing sheet.

FIG. 13E shows a close-up of the second adhesive of the mounting film as the top layer is pulled back.

FIG. 14 shows a plan view of a canvas sheet with identifier-marked bubbles—specifically numbers—and a legend to the left of the canvas sheet, as a point of comparison with the embodiments disclosed herein.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

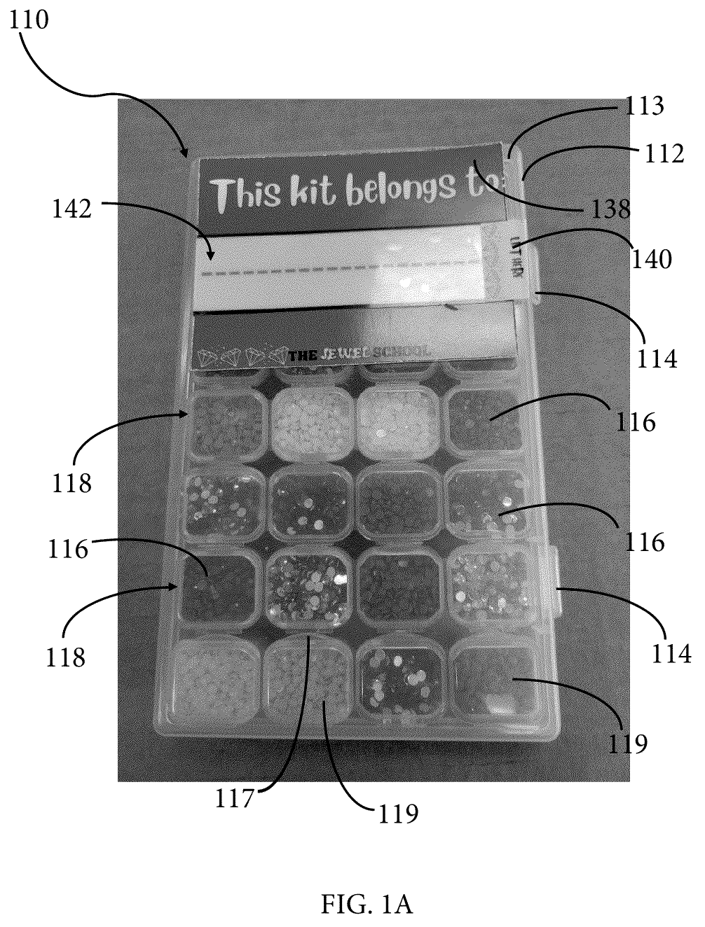

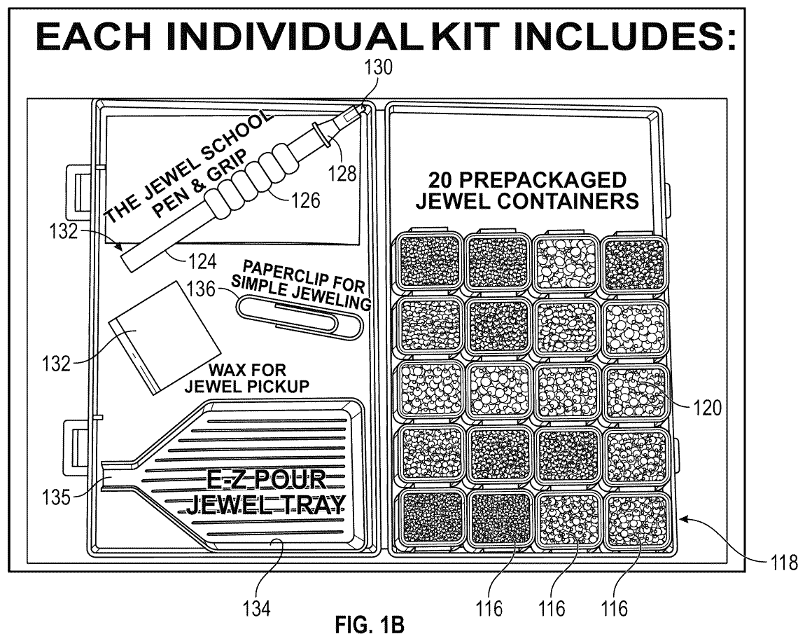

FIGS. 1A-1B are discussed together. FIG. 1A is a plan view of a diamond painting kit 100. FIG. 1B is a plan view of the diamond painting kit but opened. The diamond painting kit 100 comprises a housing 112, a housing top 113, at least one tab 114, a plurality of containers 116, each of the plurality of containers comprising a tab 117, at least one row 118, and a top 119. The diamond painting kit 100 further comprising a plurality of diamond beads 120, a utensil 122, a wax shape 132, a bead tray 134, a paperclip 136, a label 138, a lift-here peel 140, and a do it yourself line (DIY line) 142. The utensil 122 includes a shaft 124, a grip 126, a tip 128, and an aperture 130. Further, the bead tray 134 includes an opening 135.

The diamond painting kit 100 includes the housing 112, which includes a housing top 113, to which is connected the at least one tab 114 by which the housing 112 can be opened and/or sealed by moving the at least one tab 114. The at least one tab 114 can be locked into place for keeping the housing 112 closed, or can be unlatched to allow free access to a volume inside the housing 112. As understood by those of ordinary skill in the art, there are multiple ways to open and close the housing 112 and is not limited to the at least one tab 114. Non-limiting examples can include a hook and loop fastener, zippers, snap-buttons, magnets, twist-locks, buckles, clasps, slide fasteners, etc. without deviating from the scope of the present discloser. In the present example, the at least one tab 114 is connected to the housing top 113, and the at least one tab 114 secures itself around an at least one flange (not shown) that is one the housing 112, but not connected to the housing top 113.

Inside the housing 112 are included the plurality of containers 116. In the present example, there are twenty total of the plurality of containers 116. Each of the plurality of containers 116 may include a square or rectangular shape so as to easily fit inside of the housing 112. In 3D terminology, each of the plurality of containers 116 may be of a parallelepiped. Although these shapes are the preferred embodiment for fully utilizing a space within the housing 112, it is understood that there are alternative shapes for each of the plurality of containers that can fully utilize the interior of the housing 112. Nonlimiting examples include patterns of triangular, rhombus, or circular shapes, wherein the circular shapes would include varying sizes so as to fully utilize the space within the housing 112. Further, as understood by those of ordinary skill in the art, differing sizes of shapes and combinations of different shapes of the plurality of containers 116 are possible to include variety and fun in a diamond painting process. Non-limiting examples include a large isosceles, right-angle triangle in one corner of the diamond painting kit 100, and two smaller isosceles, right-angle triangles, the hypotenuse of each of the smaller isosceles, right-angle triangles adjacent to and traversing an entirety of a hypotenuse of the large isosceles, right-angle triangle, and then further including multiple smaller square shapes for the plurality of containers 116 to fill in the rest of the space within the housing 112.

Each of the plurality of containers 116 may be organized into variations of the at least one row 118. The present example includes four of the plurality of containers 116 to one of the at least one row 118, wherein each of the four of the plurality of containers 116 are connected so as to come out as a group if a user were to lift one out of the four of the plurality of containers 116 within one of the at least one row 118. Having four of the plurality of containers 116 within a single row allows for easier organization, wherein a user can take one of the at least one row 118 out of the housing 112 and either work with only the four of the plurality of containers 116 that were removed from the housing 112, or the user could place multiple of the at least one row 118 wherever they desire around their workspace with less concern of knocking over and spilling a single container of the plurality of containers 116 because four-in-a-row of the plurality of containers 116 each connected allows for greater stability and less of a chance of spilling. It is contemplated that in the at least one row 118 of four containers, that one of the plurality of containers within that at least one row 118 may be detached and/or reattached to the at least one row 118. Non-limiting examples can include a hook and loop fastener, zippers, snap-buttons, magnets, twist-locks, buckles, clasps, slide fasteners, etc. as understood by those of skill in the art.

It is contemplated that in the event that the shapes of the plurality of containers 116 is something other than a square or rectangle that varying combinations of the at least one row 118 are possible. Non-limiting examples include two triangles pressed together to form a square, or pressed together to form a rectangle, or a rhombus, and would thus comprise two of the plurality of containers 116 that are connected to make one of the at least one row. Further non-limiting examples include multiple of the previously described combination, wherein multiple triangles that form squares/rectangles/rhombi are connected together to form one of the at least one row 118. In this example, there may include eight triangles within or on the at least one row 118, or more, or less. As understood by those of ordinary skill in the art, other combinations are possible that can include varying sizes of circles etc.

Each of the plurality of containers 116 includes one of the tab 117. The tab 117 placed on each of the plurality of containers 116, similar to the at least one tab 114 of the housing 112, is capable of opening or closing one of the plurality of containers 116. Similar to the at least one tab 114, as understood by those of ordinary skill in the art, there are multiple ways to open and close each of the plurality of containers 116 and is not limited to the tab 117. Non-limiting examples can include a hook and loop fastener, zippers, snap-buttons, magnets, twist-locks, buckles, clasps, slide fasteners, etc. without deviating from the scope of the present discloser. Moreover, different types of fasteners can be used for different of the plurality of containers 116 to add variety and make the diamond painting kit 100 more fun. However, in the present example, each of the plurality of containers 116 includes just the tab 117 for convenience and ease in manufacturing processes, thus reducing cost of the diamond painting kit 100.

Similar to the housing top 113, each of the plurality of containers 116 includes a top 119 in which each of the different tabs 117 are connected to one top 119 for one of the plurality of containers 116. Disposed inside of each of the plurality of containers 116 are the plurality of diamond beads 120. The plurality of diamond beads 120 includes a variety of different colors of the plurality of diamond beads 120. The variety of colors is not limited to any particular color scheme as each of the diamond painting kits 100 can include a variety of differing colors. A non-limiting example includes pink plurality of diamond beads 120 in one of the plurality of containers 116, white plurality of diamond beads 120 in another of the plurality of containers 116, blue and silver plurality of diamond beads 120 in another container of the plurality of containers 116, and so on. Lifting the top 119 by accessing the tab 117 of an individual container within the plurality of containers will grant access to grabbing, grasping, or pouring the plurality of diamond beads 120 from the individual container.

Each individual diamond bead of the plurality of diamond beads 120 may be easily picked up or grasped by the utensil 122. The utensil 122 can comprise the shaft 124, the grip 126 surrounding the shaft 124, the tip 128 at a first end of the shaft 124, the tip 128 being conical in shape with the aperture 130 at a periphery of the tip 128, and the tip 128 tapering to a vertex connected with the first end of the shaft 124. The aperture 130 has roughly the same diameter as one bead of the plurality of diamond beads 120 so as to facilitate picking up the bead and ease of letting go of the bead without the bead getting stuck in the aperture 130 or the diamond bead not being picked up at all by the utensil 122.

Also within the diamond painting kit 100 are the wax shape 132, the bead tray 134, and the paper clip 136. The wax shape 132 may be any shape and in the current example is roughly that of a square. The wax shape 132 can be used to press the utensil 122 into, and leave the aperture 130 of the utensil 122 in a prepared state to more easily pick up the each of the plurality of the diamond beads 120. Further, the wax shape 132 can be used to pick up the plurality of diamond beads 120 once it is time to clean up. The wax shape 132 allows for ease in picking up many of the plurality of diamond beads 120 at once, and replacing the plurality of diamond beads 120 back within their respective container of the plurality of containers 116. The bead tray 134 is capable of holding many of the plurality of beads 120 in a single space in which the user may desire to pick up one of the beads from the plurality of beads 120 within the bead tray 134. Alternatively, users may pour the plurality of beads 120 from the bead tray 134 and into one of the plurality of containers 116. The bead tray 134 funnels toward a first end of the bead tray 134 to a width that can accommodate no more than two of the plurality of diamond beads 120 widths side-by-side for the opening 135 to allow beads to slide through. Further, the bead tray 134 includes raised edges surrounding a perimeter of the bead tray 134 (excluding the opening 135) to help contain the plurality of beads 120 within the bead tray 134, the only opening being the opening 135 at the first end of the bead tray 134. As understood by those of ordinary skill in the art, the opening 135 may be a different width so as to allow more or fewer of the plurality of diamond beads 120 to pass through when pouring.

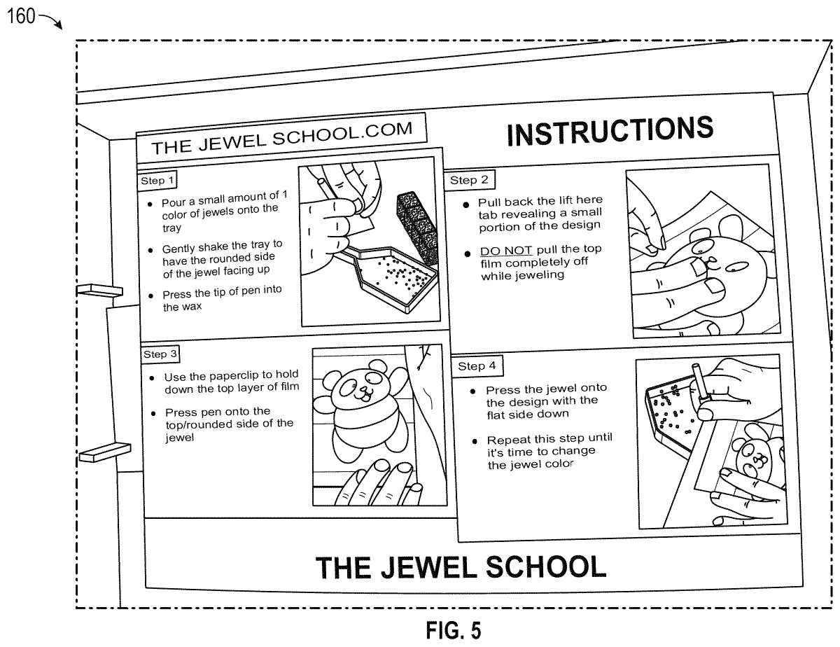

Further, the wax shape 132 which may be used to pick up the plurality of diamond beads 120 and then scraped along the raised edges on the bead tray 134 for easier clean up (by picking up large amounts of the plurality of diamond beads 120, scraping them into the bead tray 134, and then pouring the plurality of diamond beads 120 into one of the plurality of containers 116). Furthermore, the wax shape 132 can be used to catch the plurality of beads 120 from the user pouring the plurality of beads 120 out of one of the plurality of containers 116 such as when a doctor dumps a dab of alcohol from a bottle onto a cloth. The wax shape 132 will catch a desired amount of the plurality of diamond beads 120 which the user can then place the plurality of containers 116 back upright, and scrape the plurality of diamond beads 120 from off the wax shape 132 and into the bead tray 134, thus providing a way for a cleaner and more organized way to jewel. The paperclip 136 will be discussed in further detail in conjunction with FIG. 5.

Disposed on top of the housing top 113 is the label 138. The label 138 has the lift-here peel 140 and the DIY line 142. The lift-here peel 140 may be grabbed by the user and pulled back to reveal the DIY line 142, and the lift-here peel 140 may be put back down onto the DIY line 142 for accessing the DIY line 142 at a later time. In the present example, the lift here peel 140 includes a transparent portion for greater ease in seeing the DIY line 142. The DIY line 142 allows for a starting place to use the diamond painting kit 100, in which the user may begin customization with their diamond painting kit 100.

First, the user opens the housing 112. Next, the user selects which colors the user will use, and pulls out the respective containers of the plurality of containers 116. Next, the user pulls the utensil 122 out of the housing 112 and opens the containers containing the chosen colors from the plurality of containers 116 that were removed from the housing 112. Next, the user closes the housing 112. After this step, the user then pulls back the lift-here peel 140. After revealing the DIY line 142, the user may then pull beads of their color choice from the plurality of containers 116 that are opened by using the utensil 122. By grasping one bead at a time with the utensil 122, the user may then release the one bead from the utensil by sticking it to the DIY line 142 and spell their name on the DIY line with the plurality of diamond beads 120 upon a sticky surface that is revealed upon lifting the lift-here peel 140. Then, once the placed plurality of diamond beads 120 have been placed according to the user's desire on the DIY line 142, the user may then re-apply the lift-here peel 140 for protection of the placed plurality of diamond beads 120, or may alternatively remove the lift-here peel 140 entirely for aesthetic. This process of applying the plurality of diamond beads 120 to an object may be referred to as jeweling, diamond painting, or diamond coloring.

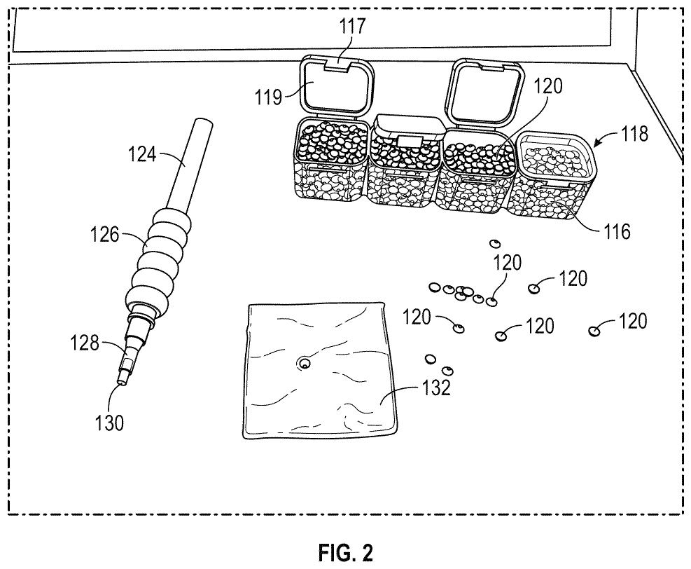

FIG. 2 includes the utensil 122, a single row of the at least one row 118 removed from the housing 112, the plurality of diamond beads 120 both within the plurality of containers 116 and without, and the wax shape 132.

FIG. 2 gives a better view of how the at least one row 118 has four of the plurality of containers 116 connected to one another. Further, FIG. 2 shows three of the four of the plurality of containers 116 open, with a single of the plurality of containers 116 remaining shut. As shown by FIG. 2, the plurality of diamond beads 120 can quite easily lead to a mess if spilled. While the wax shape 132 is not necessary to be included in the diamond painting kit 100, it allows for greater ease in picking up multiple of the plurality of diamond beads and removal thereof into the plurality of containers 116. Finally, FIG. 2 gives an alternative perspective of the utensil 122.

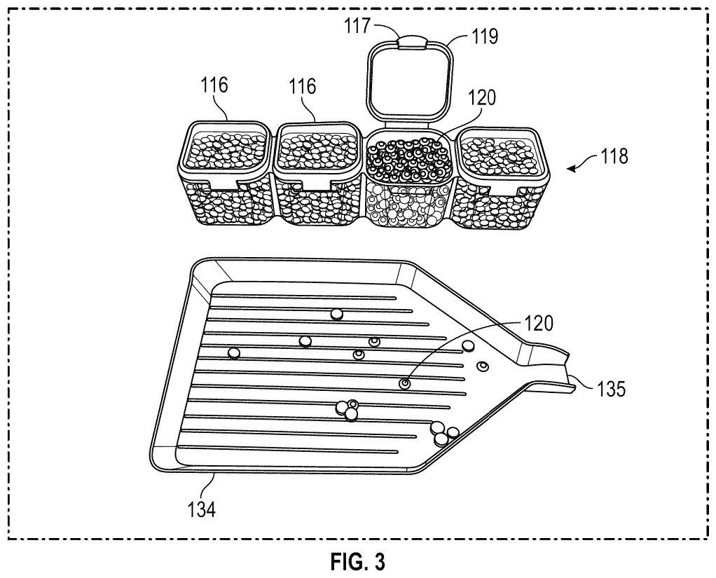

FIG. 3 builds off FIG. 2 but only includes the single row of the at least one row 118 (removed from housing 112), some of the plurality of diamond beads 120, and the bead tray 134.

While the bead tray is optional to include in the diamond painting kit 100, shown in FIG. 3 are some of the plurality of diamond beads 120 placed within the bead tray 134. These diamond beads may have been placed here by pouring them into the bead tray 134 directly from one of the plurality of containers 116 (as can be seen in FIG. 3, only one of the plurality of containers 116 is opened form the four that are connected in the at least one row 118, and thus only that color would have been poured out if that was how the plurality of diamond beads ended up in the bead tray 134), or they may have ended up in the bead tray 134 by being scraped from the wax shape 132 against the raised edge of the bead tray 134. As can be seen by FIG. 3, ridges disposed on the bead tray 134 are spaced apart the diameter of a single diamond bead for easier separation and organization should the user desire to diamond paint directly from the bead tray 134 rather than from the plurality of containers 116.

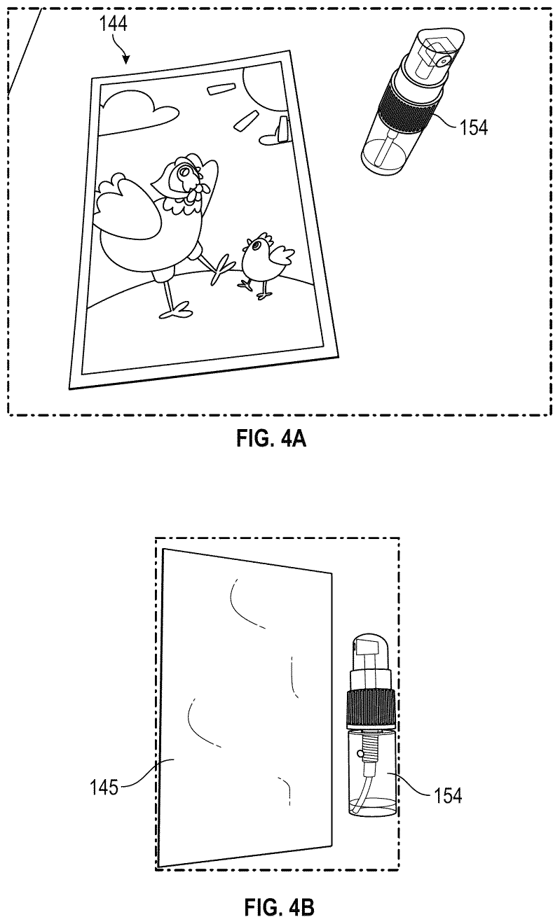

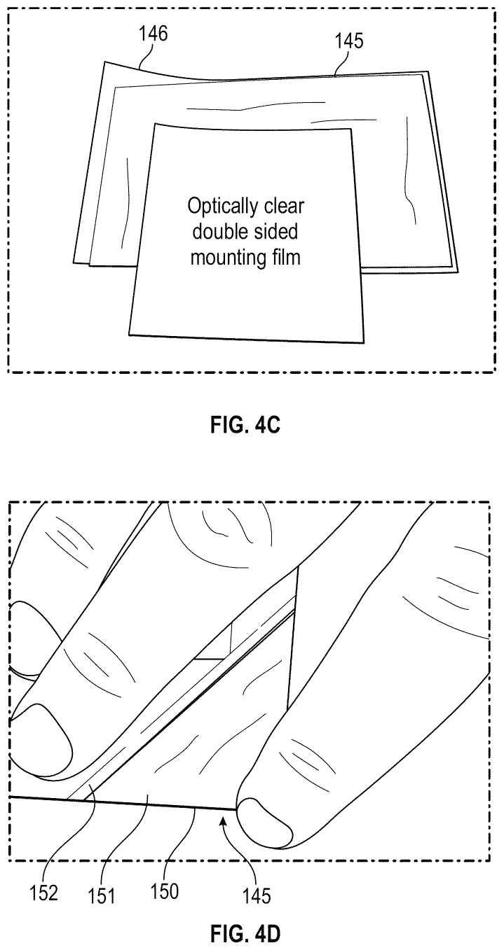

FIGS. 4A-4D will be discussed together. FIGS. 4A-4D include a drawing sheet 144, a blank drawing sheet 145, an optically clear double-sided mounting film 146 (mounting film 146), and a water sprayer 154. The mounting film 146 comprises from bottom-to-top a first peelable side 148, a first adhesive 149, a polyester film 150, a second adhesive 151, and a second peelable side 152.

FIGS. 4A-4D show various ways to begin with a piece of paper and ultimately end with creative designs of the plurality of beads 120 positioned on and attached to the paper. As shown in these figures, the paper can have an image premade thereon or can start blank for a user to leave blank or draw their own image thereon. The paper can then have either of water-activated glue or a mounting film applied thereon for prepping the paper to receive the plurality of beads thereon, and after being prepped the plurality of beads 120 can be attached thereto either following an image premade or drawn on the paper or deviating from an image or simply creating designs from scratch with the plurality of beads 120 attached to the paper.

FIG. 4A shows a perspective view of the drawing sheet 144 covered with a water-activated glue and a pre-made image thereon, and the water sprayer 154 separate from the drawing sheet 144. FIG. 4B includes the blank drawing sheet 145 and the water sprayer 154 separate from the blank drawing sheet 145. FIG. 4C includes the mounting film 146 above the blank drawing sheet 145. FIG. 4D includes the user peeling a portion of the second peelable side 152 away from the polyester film 150 (with the second adhesive 151 in between the polyester film 150 and the second peelable side 152), of the mounting film 146 that has been attached to the blank drawing sheet 145.

In FIG. 4A, the drawing sheet 144 with the water-activated glue already applied may have water lightly sprayed thereon to activate the water-activated glue and then may have the plurality of diamond beads 120 applied thereon. In this regard, once the glue is activated it will have sticking properties that make application of the plurality of diamond beads 120 easy and allow the plurality of diamond beads 120 to stay attached to the drawing sheet 144 once applied. The water-activated glue is an adhesive that comprises a synthetic copolymer/homopolymer based proprietary blend that can be purchased from Adhesive Compounders Inc. located at 326 SW 5th St., Des Moines, IA. The alternative is to use a natural based cornstarch which would not work as there may be problems related to adhesion strength, absorption rate (water being absorbed into the drawing sheet 144), and humidity and temperature sensitivity.

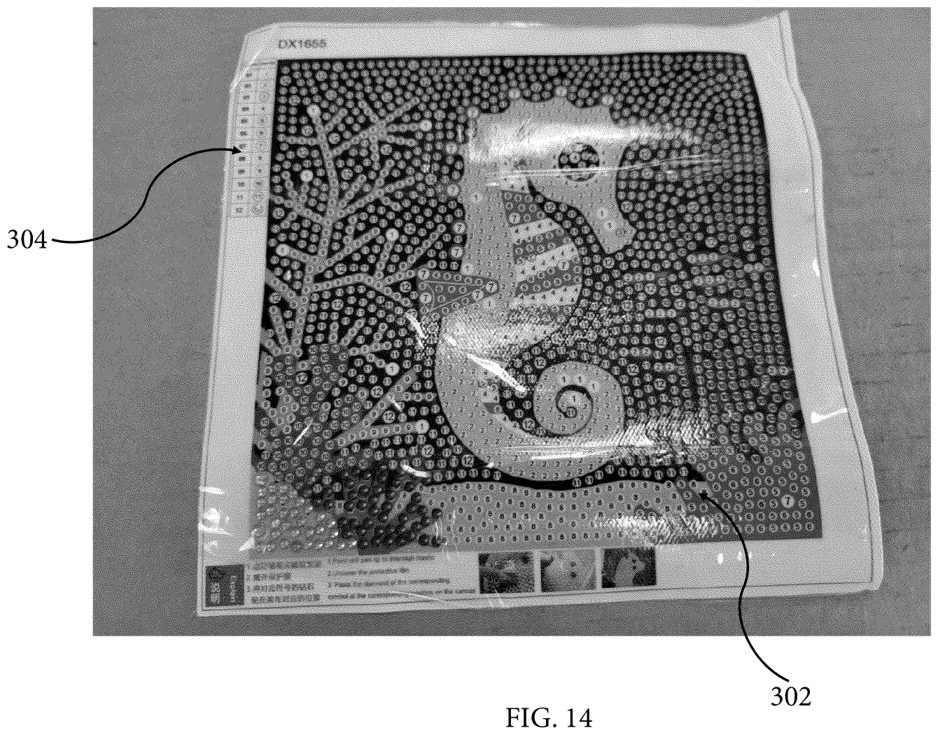

The drawing sheet 144 has the pre-made image, but does not include the legend 304 or the mapped image 302 that are shown in the prior art in FIG. 14. In this regard, more creativity and imagination are fostered with respect to decorating the drawing sheet 144 with the plurality of diamond beads 120. Although not shown, the drawing sheet 144 may come without the water-activated glue, and may instead be plain cardstock with nothing on the plain cardstock but the pre-made image thereon. This can allow for the mounting film 146 to be applied thereon instead of activating a glue with water to stick the plurality of diamond beads 120 to the drawing sheet 144.

In the case of the blank drawing sheet 145 shown in FIG. 4B, the blank drawing sheet 145 has not had either the water-activated glue or the mounting film 146 applied thereon. In this regard the blank drawing sheet 145 may either have the water-activated glue or the mounting film 146 in order to apply the plurality of diamond beads 120 to the blank drawing sheet 145. Should a user desire to have water-activated glue instead of applying a mounting film thereon, the water sprayer 154 can be used to activate the water-activated glue making the blank drawing sheet 145 ready to receive the plurality of diamond beads 120 for sticking and staying attached to the blank drawing sheet 145. Further, as understood by those of ordinary skill in the art, the blank drawing sheet 145 can be drawn on by a user to create images (not a pre-applied image, rather something of the user's own creation) before applying either of the water-activated glue or the mounting film 146 thereto.

Should the user instead desire to apply the mounting film 146 instead of the water-activated glue, to apply the mounting film 146 the user first cuts the mounting film 146 to match the shape of the perimeter of the drawing sheet 144, or blank drawing sheet 145, as shown in FIG. 4C. The drawing sheet 144 or blank drawing sheet 145 most often comprises cardstock. In the present example, the drawing sheet 144 is premade by a manufacturer with a predesignated image, and the mounting film 146 is premade by the manufacturer to already be the same size and shape as the drawing sheet 144.

Next, the user peels off the first peelable side 148 of the mounting film 146 to reveal the first adhesive 149 of the mounting film 146 which is between the first peelable side 148 and the polyester film 150. Once the first peelable side 148 has been fully removed, the user then places the mounting film 150 onto the drawing sheet 144 or blank drawing sheet 145. The first adhesive 149 is pressure sensitive, and thus will activate once pressed (no heat or water required) to either of the drawing sheet 144 or the blank drawing sheet 145, and the mounting film 146 will then act as lamination to the drawing sheet 144/blank drawing sheet 145, while simultaneously providing a sticking surface (the second adhesive 151) for the plurality of diamond beads 120 to stick to. When the user is ready to begin jeweling, the user will peel back the second peelable side 152 of the mounting film 146 as shown in FIG. 4D, which will reveal the second adhesive 151 above the polyester film 150 that is attached to the drawing sheet 144/blank drawing sheet 145 via the first adhesive 149 sticking to the drawing sheet 144/blank drawing sheet 145. The user can either partially or fully remove the second peelable side 152 to reveal some of the second adhesive 151 or all of the second adhesive 151. Then, the user may begin jeweling by taking from the plurality of diamond beads 120 with the utensil 122, and begin applying bead-by-bead the plurality of diamond beads 120 to the second adhesive 151 atop the polyester film 150 which is on top of the drawing sheet 144/blank drawing sheet 145. The user may then replace the second peelable side 152 of the mounting film 146 over the plurality of diamond beads 120 that have been applied to the drawing sheet 144/blank drawing sheet 145 to come back and finish jeweling later or simply to cover already-applied beads 120 to act as a lamination over the art piece.

The first adhesive 149 and the second adhesive 151 are made of the same adhesive and are on opposite sides of the polyester film 150, each covered by the first peelable side 148 or the second peelable side 152 respectively. This adhesive comprises optically clear 204-4100 permanent acrylic adhesive. This adhesive (first adhesive 149 and second adhesive 151) fully covers both sides of the polyester film 150, and the first peelable side 148 and the second peelable side 152 (which cover the adhesive 149/151) each comprise an optically clear 1.0-1.5 mm polyester film liner. The polymer film 150 can be 1 mm in width. The entirety of the mounting film 146 is optically clear.

As understood by those of ordinary skill in the art, while useful the utensil 122 is not required. It is contemplated that the utensil 122 be replaced by using the user's hands and fingers to apply the plurality of diamond beads 120 to the first adhesive 151.

As understood by those of ordinary skill in the art, given that both the drawing sheet 144 and the mounting film 146 come from the manufacturer, the manufacturer may simply pre-create the drawing sheet 144/blank drawing sheet 145 with the mounting film 146 pre-attached, or not pre-attach the mounting film 146 and simply include the drawing sheet 144/blank drawing sheet 145 with the mounting film 146 for a user to self-attach, or the manufacturer could simply not include the mounting film 146 at all and simply have the water-activated glue pre-applied to either the drawing sheet 144/blank drawing sheet 145, the user only needing to activate the glue with water to begin jeweling. Thus, the user could purchase a diamond painting kit 100 including the drawing sheet 144/blank drawing sheet 145 (or multiples thereof) with the mounting film 146 separately included. Or the mounting film 146 could already be attached to the drawing sheet 144/blank drawing sheet 145 in which the user would only need to peel back the second peelable side 152 of the mounting film 146 before the user could begin applying the plurality of diamond beads 120 atop the second adhesive 151 atop the polyester film 150. As will be explained below, there are certain advantages to each of these situations.

There may be users that desire to have some sort of pre-made image to color-in just like a coloring book, in which either the manufacturer pre-applying the mounting film 146 to the drawing sheet 144 or not including the mounting film 146 at all and just having the water-activated glue atop the drawing sheet 146 would be preferred for these users. There may be other users who prefer to entirely create on their own a drawing from scratch on the blank drawing sheet 145. In these cases, it is preferable to provide these other users with the blank drawing sheet 145, and the mounting film 146 separately so as to foster their creativity so that they can apply the mounting film 146 to their drawing once they have completed their drawing their own design on the blank drawing sheet 145.

There are many advantages to the present disclosure. First of which being that jeweling can decrease stress and anxiety. The prior art shown in FIG. 14, although helpful, can diminish this benefit of reducing stress and anxiety by giving children or artists (users) increased anxiety, especially those who are not completionists. The legend 304 can create a sense of demand similar to the feeling of homework and each bubble in the mapped image 302 of FIG. 14 can feel like a checkbox that must be marked off and can only be done in one correct way and now placed before the user is a demanding project that has thousands of checkboxes placed before them. The present disclosure avoids these discomforts and fosters creativity in the user. Rather than feel obligated to create a picture by jeweling to the exact demands of a 1000-bubble long checklist, the user can fill in each larger area of a premade image on the drawing sheet 144 with whatever color they desire, and with multiple colors if they so desire. Further, having the blank drawing sheet 145 opens an entire world of possibilities open to those who love jeweling that were previously limited only to mapped images 2 and legends 4 that had the stick-enough canvas to allow diamond beads to be connected thereon. As will be further revealed, there are many possibilities to what the present disclosure can accomplish.

FIG. 5 shows a method 160 of jeweling with the diamond painting kit 100. The method includes pouring a small amount of one of a chosen color of the plurality of diamond beads 120 onto the bead tray 134, and gently shaking the bead tray 134 to have a rounded side of the plurality of diamond beads 120 facing up. Next, is pressing the tip 128 of the utensil 122 into the wax shape 132 to make it easier for the utensil 122 to pick up each of the plurality of diamond beads 120. The method 160 further includes peeling back the second peelable side 152 to reveal a portion of the drawing sheet 144. The user may completely remove the second peelable side 152 if so desired, although it is recommended to keep a portion of the second peelable side 152 on the drawing sheet 144 so as to easily be able to re-apply the second peelable side 152 flush with a perimeter of the drawing sheet 144 and to not make the laminating of the second peelable side 152 onto the drawing sheet 144 skewampus or askew. Therefore, it is recommended that the user peel back a portion of the second peelable side 152.

Next in the method 160 is using the paperclip 136 to hold down a peeled portion of the second peelable side 152 onto a non-peeled portion of the second peelable side 152. Next is pressing the utensil 122 onto the top of one of the plurality of diamond beads 120. Next is pressing the one of the plurality of the diamond beads 120 onto the second adhesive 151, which is atop the drawing sheet 144, with a flat side of the one of the plurality of the diamond beads 120 downward. Finally, repeating these steps upon the drawing sheet 144 until the use of the chosen color is no longer desired.

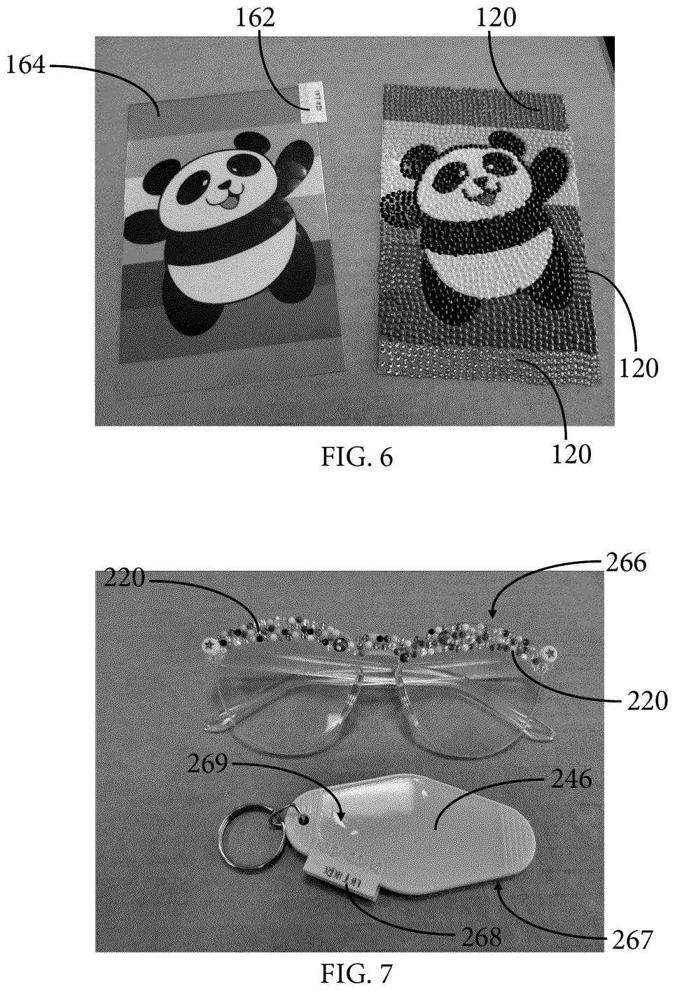

FIG. 6 is shown in color and shows a before and after of completing the method 160. In FIG. 6, a lift-here tab 162 has been added to the second peelable side 152 for ease in removing the second peelable side 152. The drawing sheet 144 in FIG. 4A is different from a drawing sheet 164 shown in FIG. 6 in that the drawing sheet 164 has pre-applied colors that a user can follow if so desired. Note how in FIG. 6 that the applied plurality of diamond beads 120 match the colors of the drawing sheet 144. In this instance, the drawing sheet 164 may be preferable to the drawing sheet 144 of FIG. 4, however, the preferred embodiment may be the blank drawing sheet 145 to other users which prefer a greater amount of self-creativity in which the user can create their own design by drawing it in and then filling their design in with the plurality of diamond beads according to how they desire.

FIG. 7 includes a jeweled pair of glasses 266 with some of the plurality of diamond beads 120 applied thereon, and further includes a customizable keychain 267 with a lift-here tab 268 and a blank area 269 upon the keychain 267 whereupon the plurality of diamond beads 220 can be applied after the lift-here tab 268 has been removed.

Objects such as the glasses 266 and the keychain 267 are great candidates for things that can be jeweled due to non-textured surfaces that they have, and the process to jeweling them includes the following. Finding an object with a non-textured surface, cleaning the non-textured surface from dust or debris, cutting the mounting film 246 to match a shape of the non-textured surface, removing the first peelable side 248 from the mounting film 146, and applying the peelable side 246 to the non-textured surface. Although not necessary, the process can further include applying the lift-here tab 268 to the second peelable side 252. Furthermore, the process may include removing the second peelable side 252 and applying the plurality of diamond beads 220 to the polyester film 250 (revealed by removing the second peelable side 252). Moreover, the process may not have the mounting film 246 at all and instead a water-activated glue may exist on the glasses 266 and the process may then include lightly spraying water on the water-activated glue before applying the plurality of diamond beads 220 to the polyester film 250. Even further, the process may further include applying different types of beads that are not diamond beads. As shown in FIG. 7, the glasses 266 have at an outermost periphery on either side a bead with a star centered thereon for greater creativity.

As understood by those of ordinary skill in the art, the cutting step may go even further to cutting the mounting film 246 to a desired shape that will fit within a boundary of the non-textured surface, wherein the desired shape does not match the shape of the non-textured surface. The glasses 266 are a great example of this alternative way of doing this process. As shown in FIG. 7, only a top portion of the glasses 266 actually has the mounting film 246 applied thereto, said portion being an area that cover where a set of eyebrows usually sit behind the glasses 266, and the plurality of diamond beads 220 are only able to stick to this area that covers where the set of eyebrows usually sit. In this regard, although the optically clear double-sided mounting film 246 could cover an entirety of a surface on the glasses 266 as the user would still be able to see through the mounting film 246, this may not be desirable if it were to change the reflective qualities of peering through the glasses 266, and thus it would be preferred to only apply the mounting film 246 to the area that covers where the set of eyebrows usually sit. This is not to say that the mounting film 246 has any particular reflective qualities, rather that there are many pairs of glasses that do have specific reflective qualities which individuals pay extra money for and may not want to tamper with their selected reflective qualities if the mounting film 246 did not match the same specific reflective qualities as the glasses 266. As understood by those of ordinary skill in the art, the mounting film 246 may be pre-applied to the glasses 266 so that the user does not need to attach the mounting film 246 and may simply remove the lift-here tab 268 to begin jeweling the plurality of diamond beads 220 on an adhesive revealed by lifting the lift-here tab 268.

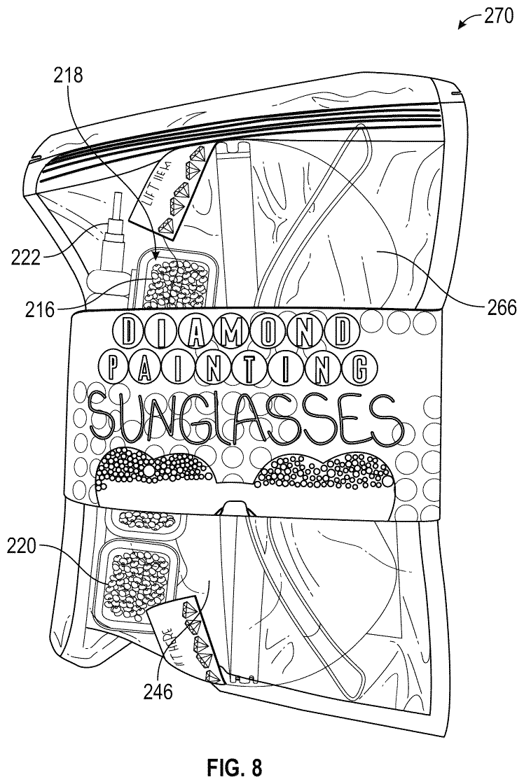

FIG. 8 shows a package 270 for storing and selling the glasses 266 before the glasses 266 are jeweled. The package 270 can include and/or stores the plurality of containers 216, the at least one row 218, the plurality of diamond beads 220, the utensil 222, the wax shape 232 (not shown), the bead tray 234 (not shown), the mounting film 246, and the glasses 266.

The plurality of diamond beads 220 are stored within the plurality of containers 216 making up the at least one row 218. Each individual container of the plurality of containers 216 may contain different colors of the plurality of diamond beads 220. As understood by those of ordinary skill in the art, the glasses 266 may comprise different shapes of glasses 266 and/or colors of glasses 266 providing differing aesthetics and advantages such as various parts of the glasses 266 that may provide protruding shapes/designs with non-textured surfaces not normally seen on a regular pair of glasses in which the user may apply the plurality of diamond beads 220.

As understood by those of ordinary skill in the art, the kit may pre-apply the mounting film 246 to the glasses 266 for ease for users in simply removing the second peelable side 252 to begin jeweling. The second peelable side 252 may include a lift-here tab for ease in beginning jeweling. Alternatively, the package 270 may contain separate mounting film 246 and glasses 266 to allow the user greater control and fostering of creativity to apply the mounting film 246 where the user will on the glasses 266. The package 270 can include varying objects to decorate with the diamond beads 220. One such non-limiting example includes the keychain 267 to be included in the package 270. By providing the mounting film 246 with varying objects in the package 270 that have non-textured/smooth surfaces, be it cardstock, plastic, glass, metal, wood, etc. This allows the user to use their imagination in where to apply the mounting film 246, and thus where to and how to apply the diamond beads 220.

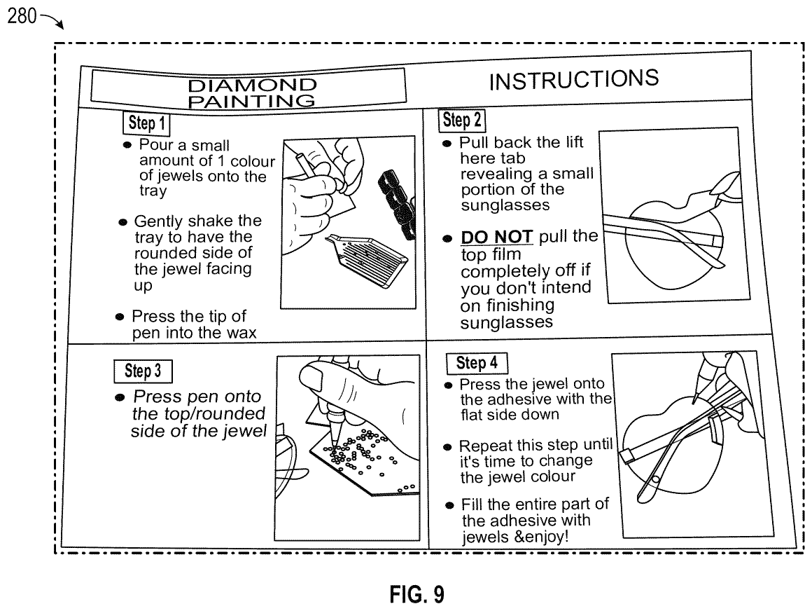

FIG. 9 includes a method 280 for jeweling the glasses 266. The method 280 first includes pouring a small amount of a single color of the plurality of diamond beads 220 onto the bead tray 234, gently shaking the bead tray 234 to have a rounded side of the plurality of diamond beads 220 facing up. Next, is pressing the tip 228 of the utensil 222 into the wax shape 232. The method 280 further includes peeling back the second peelable side 252 on to reveal the second adhesive 251 on the polyester film 250 on the glasses 266. The user may completely remove the second peelable side 252 if so desired, although it is recommended to keep a portion of the second peelable side 252 on the glasses 266 so as to easily be able to re-apply the second peelable side 252 flush with a perimeter of the glasses 266 so as to easily reapply the second peelable side 252 to the glasses 266 by avoiding making the second peelable side 252 askew so as to prevent any undesirable debris or dirt from coming in contact with the second adhesive 251 if the user intends to set the glasses 266 aside and not work on them for a period of time. Therefore, it is recommended that the user peel back a portion of the second peelable side 252.

Next in the method 280 is pressing the utensil 222 onto the top of one of the plurality of diamond beads 220. Next is pressing the one of the plurality of the diamond beads 220 onto the second adhesive 251, which is atop the glasses 266, with a flat side of the one of the plurality of the diamond beads 220 downward. Finally, repeating these steps upon the glasses 266 until the use of the chosen color is no longer desired.

As understood by those of ordinary skill in the art, the method 280 may include an additional step of applying the mounting film 246 to the glasses 266 before peeling the second peelable side 252 off. Also, the method 280 may include lightly spraying the water-activated glue (if the glasses 266 include the water-activated glue instead of the mounting film 246) with water from the water sprayer 254, in which water activates the water-activated glue.

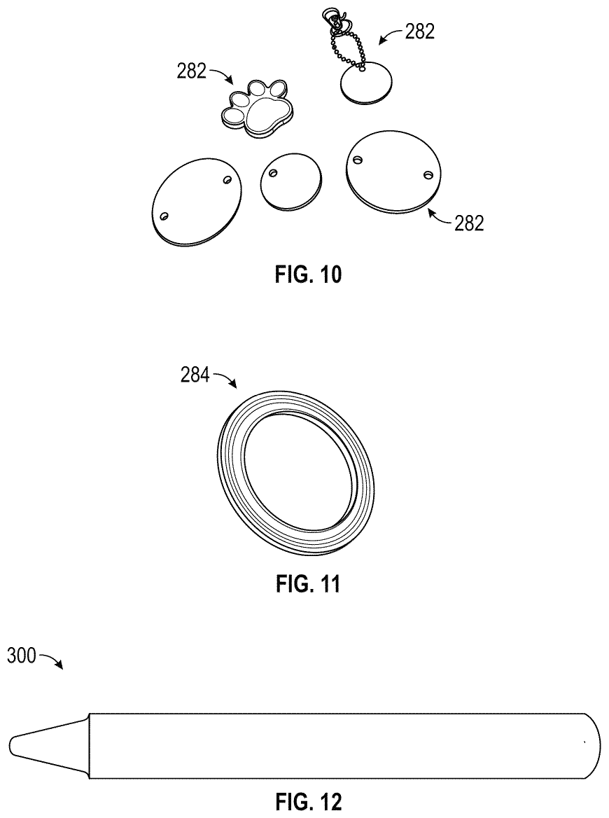

Further, the method 280 can be done differently by a process 282. The process 282 can be applied to any object that includes non-textured/smooth surfaces. The process 282 ideally follows receiving the package 270, wherein the package 270 includes the plurality of containers 216, the at least one row 218, the plurality of diamond beads 220, the utensil 222, the wax shape 232, the bead tray 234, the mounting film 246, and an object to jewel. Non-limiting examples of what the object to jewel can be include any of the glasses 266, the keychain 267, a plurality of trinkets 284 (shown in FIG. 10), a decorative piece 286 (shown in FIG. 11) and so on. As understood by those of ordinary skill in the art, the mounting film 246 can either be pre-applied to the object for greater ease to the user who will undergo the process 282, or included separately to allow the user opportunity for greater creativity. Further, as understood by those of ordinary skill in the art, each of the utensil 222, the wax shape 232, the bead tray 234, and the object are optionally included in the package 270. This is because the user may already have objects that the user desires to jewel and simply needs the plurality of diamond beads 220 in the plurality of containers 216 along with the mounting film 246 to start their own project, and in place of the utensil 222, the wax shape 232, and the bead tray 234, the user may desire simply to use their hands. However, the preferred embodiment will include each so as to provide access to tools that will make the process 282 easier, more fun, and more organized.

The process 282 can be opening the package 270, placing each of the plurality of containers 216, the utensil 222, the wax shape 232, the bead tray 234, the mounting film 246, and the object to jewel in a workspace. The process 282 further can further include opening at least one of the plurality of containers 216, thus granting access to the plurality of diamond beads 220. Next the process can include removing the first peelable side 248 from the mounting film 246 and applying the first adhesive 249 to the object. Next the process 282 may include removing the second peelable side 252 from the mounting film 246. Next the process may include lightly spraying the second adhesive 251 with water. Next the process 282 may involve removing at least one of the plurality of diamond beads 220 from the plurality of containers 216 and applying the at least one of the plurality of diamond beads 220 to the second adhesive 251.

As understood by those of ordinary skill in the art, the process 282 need not include every step just now mentioned to achieve the same result. For example, the object may already have the mounting film 246 pre-applied so as to limit the user to only peeling the second peelable side 252 as the first adhesive 249 is already applied to the object.

Furthermore, the process 282 may include further steps such as placing the utensil 222 into the wax shape 232, and pouring the plurality of diamond beads 220 into the bead tray 234, wherein the process 282 further includes gently shaking the bead tray 234 so as to turn a majority of the plurality of diamond beads 220 within the bead tray 234 right-side-up. The process 282 may then further include grasping one of the plurality of diamond beads 120 from the bead tray 234 with the utensil 222, and then applying the one of the plurality of diamond beads 220 to the second adhesive 251.

Each and every step just now mentioned regarding the process 282 may further be included in a process 183 with two small changes. The process 183 does not involve the package 270, but rather involves the diamond painting kit 100, wherein the diamond painting kit 100 would replace the package 270. Secondly, each of the steps from the process 282 may be equally applied to the process 183 except for the diamond painting kit 100 would include any or all of the drawing sheet 144, the blank drawing sheet 145, and the drawing sheet 164 instead of the object unlike the process 282. Each of any of the drawing sheet 144, the blank drawing sheet 145, or the drawing sheet 164 would replace the object in the process 282, and there can be a plurality of the drawing sheet 144, 145, or 164. Further, the process 183 may include a beforehand step of drawing or decorating the blank drawing sheet 145 to the user's desire before applying the mounting film 146 to the blank drawing sheet 145.

FIG. 10 and FIG. 11 show further objects that a user may want to jewel. FIG. 10 includes a plurality of trinkets 284 and FIG. 11 includes a decorative piece 286. The plurality of trinkets 284 come in different sizes and shapes, and may be made of wood. Laser-engraved trinkets 284 may be part of the process of the user designing their own objects to jewel, wherein the laser-engraving provides a design to follow when applying the plurality of diamond beads 220 (jeweling). FIG. 11 gives as an example the decorative piece 286 which after applying the plurality of diamond beads 220 (jeweling) can make for a self-designed ornament with whichever color-scheme the user so desires which can then be used to hang or display in various settings such as on a door, on a Christmas tree, on a poster, on a fridge, etc.

There are many advantages of providing the diamond painting kit 100 and the package 270, not only for amateur artists but also for classroom settings with children. The processes 183 and 282 can be an incredibly effective mode of teaching for teachers to his or her students. The processes 183 and 282 can be incredibly fulfilling to the students within a classroom setting while simultaneously teaching motor skills, fostering creativity, improving focus skills, enhancing decision making skills, while also decreasing stress and anxiety. The processes 183 and 282 can provide a rhythmic and repetitive nature of jeweling which can be calming. The processes 183 and 282 are a healthy distraction from everyday stressors and a productive alternative to other distractions such as passive screen time or non-interactive activities, and other less productive distractions, and is thus an excellent alternative to spending time on technology. The processes 183 and 282 can be an outlet for creativity and self-expression. The processes 183 and 282 can encourage good eye & hand coordination by allowing the user a scope to develop both mentally and physically. The processes 183 and 282 can provide a productive way to develop precise movements which help improve hand and finger dexterity.

The processes 183 and 282 further encourage decision making skills by offering color selection, pattern interpretation, planning & organizing design, while providing healthy opportunities for patience and perseverance. The processes 183 and 282 also further encourage goal setting. The processes 183 and 282 further provide opportunities for creative control over design choices and color options. Moreover, the processes 183 and 282 can help improve focus by boosting memory capacity through constant concentration, requiring precision and attention to detail, and being an enjoyable time-intensive activity in which patience is developed to see-through an entire jeweling with a rewarding result.

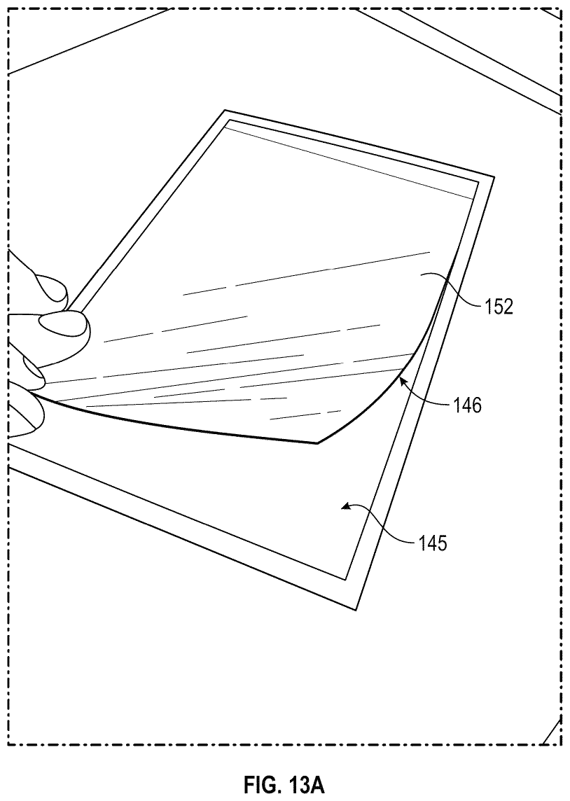

FIG. 12 shows an alternative embodiment for the utensil 122, 222 showing a colorless pencil 300. The colorless pencil 300 can be made of wax or a wax-like material that provides an ability to stick to the plurality of diamond beads such as but not limited to silicone-based adhesives (low-tack) much like silicone rubber pads used in robotic grippers, polyurethane gels, pressure-sensitive adhesives, polydimethylsiloxane elastomers and so on. The colorless pencil 300 is an alternative to the utensil 122, 222 and can also be referred to as the utensil 300. The utensil 300 is used to pick up and place the plurality of diamond beads 120, 220, and can be substituted for the utensil 122, 220 in every instance that the utensil 122, 222 has been mentioned in this disclosure. The colorless pencil may optionally include a grip 126.

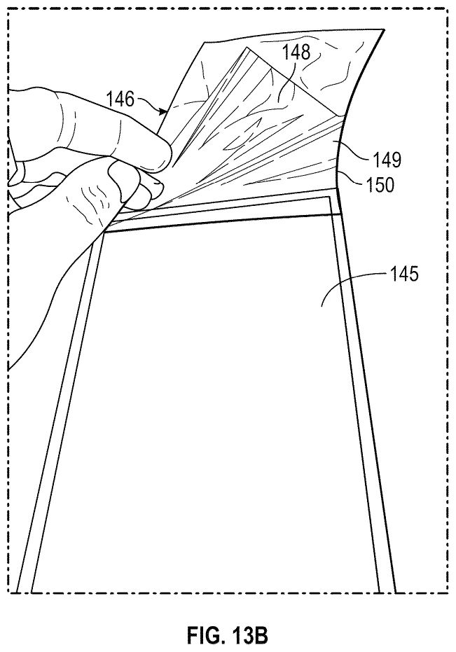

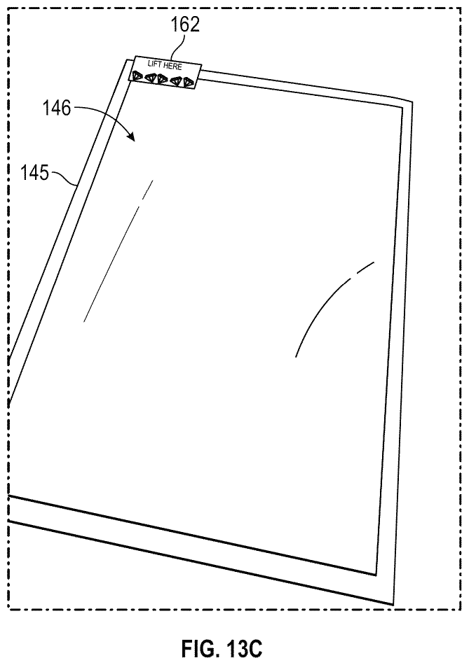

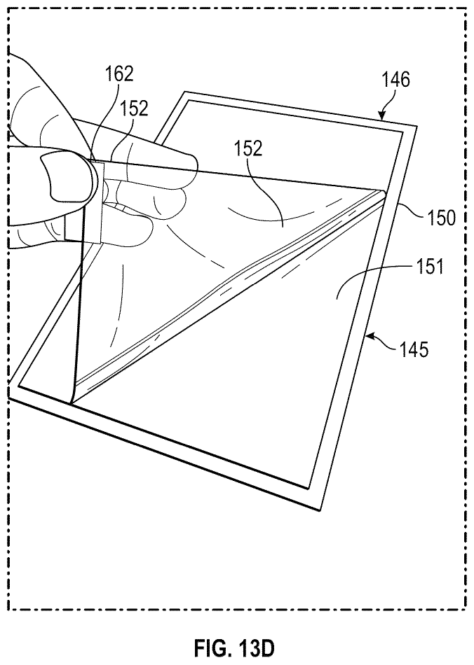

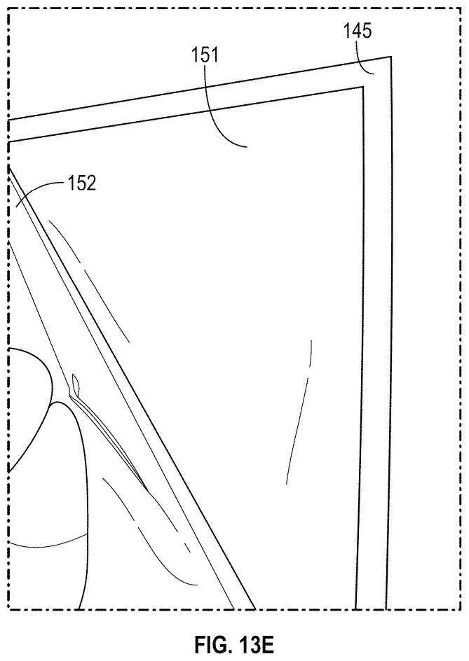

FIGS. 13A-E show a method of applying the mounting film 146 to the blank drawing sheet 145. First, as shown in FIG. 13A, is aligning the mounting film 146 with the blank drawing sheet 145, and then lifting the mounting film 146 to reveal the first peelable side 148. Next, as shown in FIG. 13B, is removing the first peelable side 148 from the mounting film 146 so as to reveal the first adhesive 149, and sticking the first adhesive 149 to the blank drawing sheet 145. FIG. 13C shows the mounting film 146 attached to the blank drawing sheet 145 with the first peelable side 148 completely removed. FIG. 13C also shows the lift-here tab 162 which may be included as a part of the mounting film 146 or alternatively is not included with the mounting film 146. If the lift-here tab 162 is included with the mounting film 142 then the first steps of aligning the mounting film 146 with the blank drawing sheet 145, lifting the mounting film 146 to reveal the first peelable side 148, removing the first peelable side 148 from the mounting film 146, and sticking the first adhesive 149 to the blank drawing sheet 145, may each be done by the manufacturer rather than the user so that the user can simply begin with the following steps that are shown in both FIG. 13D and FIG. 13E. Removing the second peelable side 152 so as to reveal the second adhesive 151 of the mounting film 146. This can be done by pulling the lift-here tab 162, or without if the mounting film 146 does not include the lift-here tab 162. Once the second peelable side 152 has been removed so that the second adhesive 151 is revealed, the user can begin jeweling by applying the plurality of diamond beads 120 to the second adhesive 151 by following the method shown in FIG. 5.

The blank drawing sheet 145 may not often include the lift-here tab 162 because the blank drawing sheet 145 may often be sought out by a user for the purpose of being able to draw their own design on the blank drawing sheet 145 before jeweling. This is difficult to do if the mounting film 146 is already applied on the blank drawing sheet 145 because removing a top layer from the mounting film 146 (the second peelable side 152) so that the user may begin jeweling results in revealing the second adhesive 151 which is more difficult to draw on than a blank cardstock that does not have the mounting film 146 applied to it. For this reason, it may be more desirable for the mounting film 146 to be included separately from the blank drawing sheet 145 (and can still include or not include the lift-here tab 162). However, this does not mean that the blank drawing sheet 145 cannot have the mounting film 146 pre-applied, because there are users that may prefer to begin jeweling on the blank drawing sheet 145 without drawing on the blank drawing sheet 145 beforehand.

As understood by those of ordinary skill in the art, the method shown in FIGS. 13A-E may also be applied to the drawing sheet 144 in which an image is pre-applied along with, or before and separate from, the mounting film 146.

FIG. 14 is a plan view of prior art. It includes a mapped image 302 that is designed to have diamond beads placed in specific places by labeling the most or the entirety of the mapped image 302 with a framework of identifier-marked bubbles including letters, numbers, or symbols inside each bubble, with each identifier (number, letter, or symbol) representing a specific bead color that should be placed therein. Included on a side of the prior art image is a legend 304 which specifies which color of beads go to which identifier-marked bubble. Although applying diamond beads to the mapped image 302 of the prior art can be beneficial to some, for those who are not completionists the mapped image 302 including the legend 304 can be anxiety inducing and simply seen as a chore, a checklist, or an overwhelming task. Further, the prior art has regularly required completing the entirety of the mapped image in one sitting because an outer layer of the mapped image 302 (covering an adhesive above the mapped image 302) once removed is not re-appliable to the mapped image 302, so once it has been removed the mapped image 302 will begin losing its stickiness, thus starting a timer as to how long one has to complete the mapped image 302 before it can no longer be worked upon.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 100 | Diamond painting kit |
| 112 | Housing |
| 113 | Housing top |
| 114 | At least one tab |
| 116 | Plurality of containers |
| 117 | Tab |
| 118 | At least one row |
| 119 | Top |
| 120 | Plurality of diamond beads |
| 122 | Utensil |
| 124 | Shaft |
| 126 | Grip |
| 128 | Tip |
| 130 | Aperture |
| 132 | Wax shape |
| 134 | Bead tray |
| 135 | Opening |
| 136 | Paperclip |
| 138 | Label |
| 140 | Lift-here peel |
| 142 | DIY line |
| 144 | Drawing sheet |
| 145 | Blank drawing sheet |
| 146 | Optically clear double-sided mounting film |
| 148 | First peelable side |
| 149 | First adhesive |
| 150 | Polyester film |
| 151 | Second adhesive |
| 152 | Second peelable side |
| 154 | Water sprayer |
| 160 | Method |
| 162 | Lift-here tab |
| 164 | Drawing sheet |
| 183 | Process |
| 216 | Plurality of containers |
| 218 | At least one row |
| 220 | Plurality of diamond beads |
| 222 | Utensil |
| 224 | Shaft |
| 226 | Grip |
| 228 | Tip |
| 230 | Aperture |
| 232 | Wax shape |
| 234 | Bead tray |
| 235 | Opening |
| 246 | Optically clear double-sided mounting film |
| 248 | First peelable side |
| 249 | First adhesive |
| 250 | Polyester film |
| 251 | Second adhesive |
| 252 | Second peelable side |
| 254 | Water sprayer |
| 266 | Glasses |
| 267 | Keychain |
| 268 | Lift-here tab |
| 269 | Blank area |
| 270 | Package |
| 280 | Method |
| 282 | Process |
| 284 | Plurality of trinkets |
| 286 | Decorative piece |
| 300 | Colorless pencil |
| 302 | Mapped image |
| 304 | Legend |

### GLOSSARY

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, sub combinations, or the like that would be obvious to those skilled in the art.

What is claimed is:

1. A diamond painting kit for jeweling, the kit comprising:
a housing;
a plurality of containers within the housing, the plurality of containers each containing a unique color of a plurality of diamond beads;
a drawing sheet;
a utensil; and
an optically clear double-sided mounting film.

2. The kit of claim 1, wherein the optically clear double-sided mounting film comprises an optically clear mounting adhesive.

3. The kit of claim 1, wherein the utensil is configured to grip a single diamond bead from the plurality of diamond beads, the utensil comprising:
(i) a shaft; a grip surrounding the shaft; and a tip at a first end of the shaft, the tip being conical in shape with an aperture at a periphery of the tip, and the tip tapering to a vertex connected with the first end of the shaft; or
(ii) a colorless pencil.

4. The kit of claim 1, wherein the colorless pencil comprises wax.

5. The kit of claim 1, further comprising a wax shape, and a bead tray, wherein the bead tray funnels toward a first end of the bead tray to a width that can accommodate no more than the combined width of two diamond beads side-by-side.

6. The kit of claim 1, further comprising a paperclip.

7. The kit of claim 1, wherein the drawing sheet is a blank drawing sheet.

8. The kit of claim 1, wherein the drawing sheet has a premade image thereon.

9. The kit of claim 8, wherein the drawing sheet further has pre-applied colors to the premade image.

10. The kit of claim 1, wherein the drawing sheet does not include a mapped image with identifier-marked bubbles, and further does not include a legend.

11. The kit of claim 1, further including a water sprayer, and a water-activated glue pre-applied to the drawing sheet.

12. The kit of claim 1, wherein the plurality of containers comprises twenty containers each in a parallelepiped shape.

13. A diamond kit for jeweling, the kit including:
a package;
a housing within the package;
a plurality of containers within the housing, the plurality of containers each containing a unique color of a plurality of diamond beads;
an object within the package;
a colorless pencil within the package; and
an optically clear double-sided mounting film within the package.

14. The kit of claim 13, wherein the optically clear double-sided mounting film comprises an optically clear mounting adhesive.

15. The kit of claim 13, further comprising a wax shape, and a bead tray, wherein the bead tray funnels toward a first end of the bead tray to a width that can accommodate no more than the combined width of two diamond beads side-by-side.

16. The kit of claim 13, further including a lift-here tab attached to the optically clear double sided-mounting film.

17. The kit of claim 13, wherein the plurality of containers comprises 4 containers each in a parallelepiped shape, the plurality of containers in an at least one row.

18. The kit of claim 13, wherein the object is glasses.

19. A process for teaching students how to jewel, the process comprising:
opening a diamond painting kit including a plurality of containers each holding differing colors of a plurality of diamond beads, the diamond painting kit further including a utensil, a bead tray, a mounting film, and a blank drawing sheet;
peeling a first peelable side from the mounting film;
applying the mounting film to the blank drawing sheet;
peeling a second peelable side from the mounting film;
opening at least one of the plurality of containers; and
applying at least one of the plurality of diamond beads to the mounting film.

20. The process of claim 19, further comprising drawing on the blank drawing sheet before applying the mounting film to the blank drawing sheet.
